(19) United States
(12) Patent Application Publication
(10) Pub. No.: US 2005/0167876 A1
(43) Pub. Date: Aug. 4, 2005

(54) Method for granulating plastics

(76) Inventor: Jan-Udo Kreyenborg, Muenster (DE)

Correspondence Address: GREENBLUM & BERNSTEIN, P.L.C., 1950 ROLAND CLARKE PLACE, RESTON, VA, 20191, US

(21) Appl. No.: 11/095,562

(22) Filed: Apr. 1, 2005

Related U.S. Application Data
(63) Continuation of application No. PCT/DE03/02945, filed on Sep. 5, 2003.

(30) Foreign Application Priority Data
Oct. 4, 2002 (DE) 102 46 464.2
Jan. 16, 2003 (DE) 103 01 382.2

(51) Int. Cl. B29C 71/00

(52) U.S. Cl. 264/140; 425/6; 264/345

(57) ABSTRACT

A process for granulating plastics having a plastic in a liquid bath of over 100° C. Wherein the liquid bath is a water bath and is in a pressurized-vessel pressure system. The instant abstract is neither intended to define the invention disclosed in this specification nor intended to limit the scope of the invention in any way.

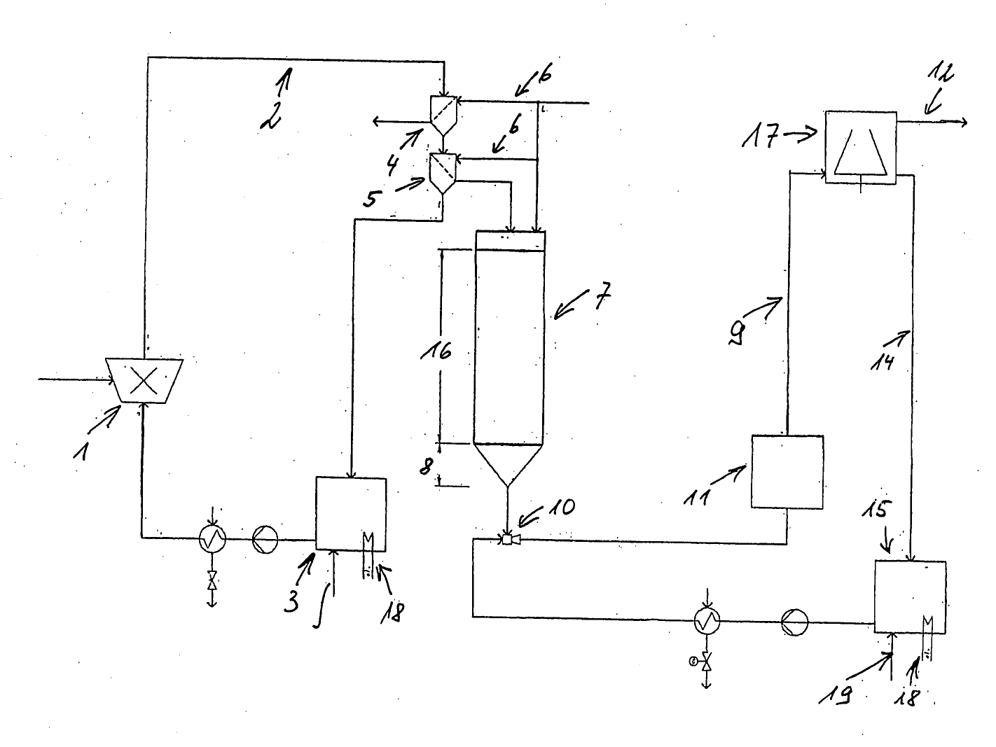

### CROSS-REFERENCE TO RELATED APPLICATIONS

The present application claims priority under 35 U.S.C. §119 of International Application No. PCT/DE2003/002945, filed on Sep. 5, 2003, the disclosure of which is expressly incorporated by reference herein in its entirety.

### BACKGROUND OF THE INVENTION

1. Field of the Invention

The invention relates to a method for granulating plastics.

2. Discussion of Background Information

All plastic granulating systems known to date operate with water temperatures of below 100° C., which limits them in their application purpose and the mode of operation for certain tasks.

With strand granulation, the plastic strands are guided either first through air into a water bath or directly from a nozzle through a water bath into the subsequent granulation.

With a water-ring granulation, the material is cut in a relatively dry state and in a terminal manner and conveyed into a water bath, if necessary.

For low-viscosity plastic materials, the so-called strip granulation is known, in which the material reaches a band drop by drop, which material is then cooled down on the band and extracted in granular form.

With underwater head granulation, the plastic material is cut by rotating blades directly after it exits from a perforated plate or nozzle plate and is then further conveyed in a water flow.

The viscosity is a decisive criterion with the granulation of polymer plastics. More and more technical plastics tend toward a very fast freezing of the perforated plate holes if the cooling effect of the water flowing by is stronger than the heating capacity together with the sensible heat of the polymer. A certain temperature difference prevails during granulation, which difference depends on the polymer and its viscosity. Even little temperature losses in the plastic cause the plastic to lose viscosity.

### SUMMARY OF THE INVENTION

A method and process is provided in which the temperature difference between the plastic directly before granulation or the granulated plastic and the liquid used for granulation is lowered.

A method for granulating plastics in which the granulation of the plastic takes place in a liquid bath of over 100° C., wherein the liquid bath is a water bath.

From the prior art, so-called post-condensation installations are known, in which newly granulated granulate is converted from the amorphous state into the crystalline state. These installations require considerable expenditure and a long retention time and have a high energy consumption and thus also high investment expenses.

The method and process includes treating new granulate for a defined period of time in correspondingly high-temperature water, i.e., water with a temperature of over 100° C., in order to thereby convert the amorphous material into crystalline material.

A method is provided for the post-condensation of plastic granulates in an amorphous state to be converted into the crystalline state. The plastic granulate produced in a granulator is treated directly after the implementation of the granulation for a period of time necessary for the crystallization in a liquid bath. The method includes the liquid bath being a water bath with a temperature of over 100° C.

A method is provided for the post-condensation of plastic granulates in an amorphous state to be converted into the crystalline state. The granulation of the plastic takes place in a liquid bath, such that the liquid bath is a water bath with a temperature over 100° C. The method includes treating the plastic granulate produced in a water bath with a temperature of over 100° C. for a period of time necessary for the crystallization.

A method including the temperature range of the liquid bath of over 100° C. is provided in a pressurized-vessel-like pressure system.

The method includes conveying the plastic granulate into the pressurized-vessel-like pressure system via a lock directly after the implementation of the granulation.

The method includes subjecting the granulate to a water separation before being fed into the pressurized-vessel-like pressure system.

The method includes conveying the plastic granulate with its residual moisture out of the pressurized-vessel-like pressure system into a water tank with a water temperature of below 100° C. for cooling purposes.

The method includes conveying the plastic granulate in the pressurized-vessel-like pressure system via a conveyance device.

It is suggested that the plastic granulate produced in a granulator is either treated directly after the implementation of the granulation for a period of time necessary for the crystallization in a liquid bath, preferably a water bath with a temperature of over 100° C.

In another method according to the invention the procedure is such that the granulation of the plastic takes place in a water bath of over 100° C. and the plastic granulate produced is further treated in a liquid bath, preferably a water bath with a temperature of over 100° C., for a period of time necessary for the crystallization.

The provision of the water bath with a temperature of over 100° C. is carried out such that the temperature range of the water bath is provided in a pressurized-vessel-like pressure system, in which the high temperature can thus be reached. The plastic granulate is conveyed in the pressurized-vessel-like pressure system via a conveyance device.

If the newly produced granulate is guided into a water bath, the temperature of which is above 100° C., the post-condensation can also be achieved in water. Thereby, the granulate is either conveyed into the high-temperature water bath via a respective lock or the granulator itself is already located in the high-temperature water bath. After the implementation of the post-condensation, the granulate is discharged via respective locks, screen and filter devices. At the end of the post-condensation reactor, the granulate can quickly be cooled down to the range of 60° C. or the like, so that henceforth a finished crystalline product exists in a closed circuit.

The advantage of subsequently conveying the granulate from the reactor into a water bath with a low temperature is also the fact that no steam subsequently escapes into the atmosphere, since this steam can previously be condensed in a so-called cooling tank.

The present invention is directed to a process for granulating plastics that includes granulating a plastic in a liquid bath of over 100° C. The liquid bath can be a water bath.

According to another feature of the invention the liquid bath is in a pressurized-vessel pressure system. Further, the plastic granulate has a residual moisture out of the pressurized-vessel pressure system, such that cooling the plastic granulate is in a water tank with a water temperature below 100° C. Further still, conveying the plastic granulate in the pressurized-vessel pressure system by a conveyance device.

The instant invention is directed to a process for post-condensation of plastic granulates to be converted from an amorphous state to a crystalline state. The process includes granulating plastic, and treating the plastic granulate in a liquid bath directly after granulation for a period of time required for crystallization. The temperature of the liquid bath is over 100° C. The liquid bath may be a water bath, the liquid bath may be in a pressurized-vessel pressure system.

According to another feature of the invention includes conveying the plastic granulate into the pressurized-vessel pressure system by a lock directly after granulation. Further, the plastic granulate is subjected to a water separation before being fed into the pressurized-vessel pressure system. Further still, the process can include conveying the plastic granulate with a residual moisture out of the pressurized-vessel pressure system. The plastic granulate maybe cooled in a water tank with a water temperature below 100° C.

According to another feature of the invention includes conveying the plastic granulate in the pressurized-vessel pressure system by a conveyance device.

Moreover, the invention is directed to a process for post-condensation of plastic granulates to be converted from an amorphous state to a crystalline state. The process includes granulating the plastic in a liquid bath over 100° C., and treating the plastic granulate in a water bath having a temperature over 100° C. for a period of time required for the crystallization. The liquid bath is a water bath, such that the liquid bath is in a pressurized-vessel pressure system.

According to another feature, the invention includes conveying the plastic granulate into the pressurized-vessel pressure system by a lock directly after granulation. Further, the plastic granulate is subjected to a water separation before being fed into the pressurized-vessel pressure system. Further still, the process includes conveying the plastic granulate having a residual moisture out of the pressurized-vessel pressure system. The plastic granulate can be cooled in a water tank with a water temperature below 100° C. Further, the process may include conveying the plastic granulate in the pressurized-vessel pressure system by a conveyance device. The process can also include sorting the granulated plastic before a crystallization zone.

The invention is directed to a granulating plastics device that includes a heating unit, and a liquid bath coupled to the heating unit, and a granulator. The liquid bath is heated to a temperature over 100° C. Further still, the liquid bath is arranged to at least one of granulate plastic in the granulator and to treat granulate plastic.

According to another feature of the invention the device may include a pressurized-vessel pressure system, a delay tank having a crystallization zone. Further, the plastic comprises a polymer that changes from an amorphous state into a crystalline state in the device.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted drawing by way of non-limiting example of an exemplary embodiments of the present invention:

The FIGURE illustrates a system for granulating plastic.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The drawing shows a granulator unit 1, into which the polymer melt is fed at a corresponding temperature and with a corresponding pressure. The granulator unit 1 is installed in a pressurized-water circuit 2, which is supplied with pressurized-water refills via a pressurized-water producer 3.

At 4, the granulates produced in the granulator 1 reach a separator device, in which undesired granulate lumps are eliminated and the desired granulate fraction together with the pressurized water is conveyed under respective pressure into a second separator tank 5. Both in the separator tank 4 and the separator tank 5 a corresponding pressurization is achieved via a pressure line 6.

The granulate from the separator tank 5 comes to a delay tank 7, whereas the water from the separator tank 5 is guided back to the pressurized-water producer 3, so that a closed circuit is created here.

The delay tank 7 forms a crystallization zone 16, whereby a cooling zone, as indicated at 8, can be present in the lower area of this crystallization zone 16.

The granulate, mixed with the water, reaches a second circuit 9, i.e., the granulate is fed into this circuit 9 together with the water via a venturi jet 10 and is then treated in a depressurization device 11 such that the pressure is controlled down to approximately ±1 bar.

From the depressurization device 11, the granulate with the water reaches a separator centrifuge 17, whereby the granulate discharge is provided at 12, whereas the separated water reaches a water treatment device 15 via a line 14. At the water treatment device, the water is heated and the water lost in the course of the process is replenished.

The heaters required for the pressurized-water producer 3 and the water treatment device 15 are discernible at 18 and the water supply lines are discernible at 19.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A process for granulating plastics comprising:
granulating a plastic in a liquid bath of over 100° C.

2. The process in accordance with claim 1, wherein the liquid bath is a water bath.

3. The process in accordance with claim 1, wherein the liquid bath is in a pressurized-vessel pressure system.

4. The process in accordance with claim 3, further comprising conveying the plastic granulate having a residual moisture out of the pressurized-vessel pressure system and cooling the plastic granulate in a water tank with a water temperature below 100° C.

5. The process in accordance with claim 3, further comprising conveying the plastic granulate in the pressurized-vessel pressure system by a conveyance device.

6. A process for post-condensation of plastic granulates to be converted from an amorphous state to a crystalline state comprising:
granulating plastic, treating the plastic granulate in a liquid bath directly after granulation for a period of time required for crystallization;
wherein the temperature of the liquid bath is over 100° C.

7. The process in accordance with claim 6, wherein the liquid bath is a water bath.

8. The process in accordance with claim 6, wherein the liquid bath is in a pressurized-vessel pressure system.

9. The process in accordance with claim 8, further comprising conveying the plastic granulate into the pressurized-vessel pressure system by a lock directly after granulation.

10. The process in accordance with claim 8, wherein the plastic granulate is subjected to a water separation before being fed into the pressurized-vessel pressure system.

11. The process in accordance with claim 8, further comprising:
conveying the plastic granulate having a residual moisture out of the pressurized-vessel pressure system; and
cooling the plastic granulate in a water tank with a water temperature below 100° C.

12. The process in accordance with claim 8, further comprising conveying the plastic granulate in the pressurized-vessel pressure system by a conveyance device.

13. A process for post-condensation of plastic granulates to be converted from an amorphous state to a crystalline state comprising:
granulating the plastic in a liquid bath over 100° C.; and
treating the plastic granulate in a water bath having a temperature over 100° C. for a period of time required for the crystallization.

14. The process in accordance with claim 13, wherein the liquid bath is a water bath.

15. The process in accordance with claim 13, wherein the liquid bath is in a pressurized-vessel pressure system.

16. The process in accordance with claim 15, further comprising conveying the plastic granulate into the pressurized-vessel pressure system by a lock directly after granulation.

17. The process in accordance with claim 16, wherein the plastic granulate is subjected to a water separation before being fed into the pressurized-vessel pressure system.

18. The process in accordance with claim 16, further comprising:
conveying the plastic granulate having a residual moisture out of the pressurized-vessel pressure system; and
cooling the plastic granulate in a water tank with a water temperature below 100° C.

19. The process in accordance with claim 16, further comprising conveying the plastic granulate in the pressurized-vessel pressure system by a conveyance device.

20. The process in accordance with claim 13, further comprising sorting the granulated plastic before a crystallization zone.

21. A granulating plastics device comprising:
a heating unit;
a liquid bath coupled to said heating unit; and
a granulator,
wherein the liquid bath is heated to a temperature over 100° C.

22. The granulating plastics device in accordance with claim 21, wherein the liquid bath is arranged to at least one of granulate plastic in the granulator and to treat granulate plastic.

23. The granulating plastics device in accordance with claim 21, further comprising a delay tank including a crystallization zone and a pressurized-vessel pressure system.

24. The granulating plastics device in accordance with claim 21, wherein the plastic comprises a polymer that changes from an amorphous state into a crystalline state in said device.
